(19) United States
(12) Patent Application Publication
(10) Pub. No.: US 2026/0367874 A1
(43) Pub. Date: Nov. 19, 2026

(54) PRE-PROCESSING ASSEMBLY FILES TO GENERATE SEMANTICALLY RICH ASSEMBLY CODE REPRESENTATIONS

(71) Applicant: Oracle International Corporation, Redwood Shores, CA (US)

(72) Inventors: Felix Schmidt, Zurich (CH); Animesh Agarwal, Dulles, VA (US); Irfan Mekic, Angier, NC (US)

(73) Assignee: Oracle International Corporation, Redwood Shores, CA (US)

(21) Appl. No.: 19/208,476

(22) Filed: May 14, 2025

(51) Int. Cl. G06F 8/30

(52) U.S. Cl. CPC G06F 8/30

(57) ABSTRACT

Example systems, methods, and computer products for generating semantically rich vector embeddings of assembly code are described. One example involves accessing a set of code in an assembly language, identifying a subset of the set of code as being less semantically relevant to a flow logic in the set of code than other subsets of the set of code, generating an assembly code representation for the set of code based on the flow logic by removing the subset of the set of code that is less semantically relevant to the flow logic from the assembly code representation and modifying the other subsets of the set of code, generating a vector embedding of the assembly code representation, storing the vector embedding in association with the set of code; and using the vector embedding of the set of code to identify code similar to a content vector embedding.

### BACKGROUND

Various software tools are designed to compare and analyze code. For example, a code comparison tool may compare two code snippets to determine whether they accomplish the same functionality. Some tools analyze code syntax, structure, variable names, comments, and/or other code elements to support code comparison. Some code comparison tools differentiate between code by finding common algorithms or design patterns, e.g., to reduce false positives or to facilitate a nuanced analysis of the code.

### BRIEF SUMMARY

In some embodiments, a computer-implemented method includes accessing a set of code in an assembly language. The computer-implemented method also includes identifying a subset of the set of code as being less semantically relevant to a flow logic in the set of code than other subsets of the set of code. The computer-implemented method also includes generating an assembly code representation for the set of code based on the flow logic by removing the subset of the set of code that is less semantically relevant to the flow logic from the assembly code representation and modifying the other subsets of the set of code. The computer-implemented method also includes generating a vector embedding of the assembly code representation. The computer-implemented method also includes storing the vector embedding in association with the set of code. The computer-implemented method also includes using the vector embedding of the set of code to identify code similar to a content vector embedding.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory and/or transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items or separate process instances of a set of process instances. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that parses assembly code to generate semantically rich assembly code representations and vector embeddings.

FIG. 2 illustrates a system diagram showing an example code semantics system that parses assembly code to generate semantically rich assembly code representations and vector embeddings.

FIG. 3 illustrates a diagram of an example user interface showing an example code semantics system that modifies raw assembly code to generate semantically enhanced assembly code according to a flow logic in the assembly code.

FIG. 4 illustrates a diagram of an example of generating vector embeddings from source code files that implement different logic flows in a high-level programming language.

FIG. 5 illustrates a diagram of an example of generating vector embeddings from assembly files that implement different logic flows in an assembly language.

FIG. 6 illustrates a diagram of an example of preprocessing assembly files to generate semantically rich assembly code representations prior to generating vector embeddings for the assembly files.

FIG. 7 illustrates a diagram of an example of using vector embeddings of semantically rich assembly code representations for code similarity analysis.

FIG. 8 depicts a simplified diagram of a distributed system for implementing certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

### DETAILED DESCRIPTION

Example systems, methods, and computer products for generating semantically rich vector embeddings of assembly code are described. In various embodiments, the generation of semantically rich assembly code representations and embeddings is implemented using non-transitory and/or transitory computer-readable storage media to store instructions which, when executed by one or more processors of a computer system, cause display of the user interface and processing of the received input to generate semantically rich assembly code representations and embeddings. The generation of semantically rich assembly code representations and embeddings may be implemented on a local or cloud-based computer system that includes processors and a display for showing the user interface to a user for generation of semantically rich assembly code representations and embeddings. The computer system may communicate with client computer systems for generating semantically rich assembly code representations and embeddings.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Code Analysis to Support Security. Reliability, and/or Efficiency

Code analysis is a process for examining code to identify potential software issues such as bugs (e.g., syntax errors, coding standard violations, undefined values, etc.), security vulnerabilities (e.g., SQL injection, cross-site scripting (XSS), etc.), and/or in-efficiencies (e.g., performance bottlenecks, etc.). Static code analysis involves analyzing code without executing the code (e.g., static application security testing (SAST), etc.). Dynamic code analysis involves analyzing behavior of a computer program during runtime or while the program is running. Code analysis could facilitate improving software quality, software security, and/or software performance. In some scenarios, code analysis could facilitate saving time and improving accuracy of software processes such as data processing programs. Code analysis could also facilitate verifying code compliance with industry standards, such as various performance standards and/or security standards.

In some examples, code analysis may be performed or assisted using one or more software tools. For example, code similarity search tools can be used to find sections of code that have similar issues, dependencies, etc., as those that were identified in a particular code section. This may be beneficial in various scenarios. By way of example, a security vulnerability may have been recently discovered in a particular code section of a codebase and where the codebase includes millions or billions of lines of code. In this scenario, a code similarity search tool can be used to quickly find other similar code sections which may potentially have the same or similar security vulnerability. Robust code analysis could facilitate other software development processes as well, such as automated software test generation and/or updating code test patterns efficiently or automatically when code updates are integrated into a codebase.

### Embedding Content of Code Sets to Support Code Analysis

Machine learning (ML) can be used to support code analysis. For example, code snippets can be used to generate vector embeddings. A vector embedding is a numerical representation of data (e.g., code snippets) as an array of numbers that ML models can process to capture their meaning and/or relationships. Thus, vector embeddings can help a computer find patterns in data, even when the data is complex. By converting code snippets into vector embeddings, an example system can compare various vector embeddings to search for similar code. For example, if a user submits a piece of code in a search query, an example system may convert the piece of code into a content vector embedding and compare the content vector embedding with vector embeddings of indexed code snippets to find an indexed code snippet that is similar to (or that is semantically relevant to) the piece of code in the search query.

In some configurations, vector embeddings are used as training data for training a ML model (e.g., neural network or other embedding model). For instance, a trained ML model can then be used to predict or compose semantically relevant code in response to text in a search query.

In some examples, ML models that were not specifically or significantly trained to understand a particular programming language can still use its understanding of natural language semantics or other semantics of a training text corpus to find similar patterns or understand certain logic flows by using vector embeddings of code sets associated with that particular programming language.

In some configurations, an example system herein is configured to use a large language model (LLM) to facilitate performing code similarity or other code analysis processes using vector embeddings input to the LLM via a prompt. For example, the system may provide the vector embeddings of code snippets via a retrieval-augmented-generation (RAG) interface of the LLM (and/or the vector embeddings can be input to the LLM via a prompt), so as to configure the LLM to search for code using the vector embeddings. For instance, a user can submit a natural code search query, i.e., a question about code in a natural language format. In this example, the system can then prompt the LLM with the natural language search query and the LLM can use the vector embeddings to identify an indexed code snippet or other set of code that is relevant to the content in the natural language search query.

In one example of an LLM-based application, a configuration command may be provided to an example system in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, Llama 3, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, a code analysis tool uses the same LLM service for users but may use different LLM sessions for different users. The LLM session may be authenticated using a token that is established to refer to a particular user session. The token may be passed by the code analysis tool to establish or re-establish the authenticated session with the LLM and begin sending prompts.

In various embodiments, prompts are generated to use information about a data schema, such as data that is formatted in a hierarchical format (e.g., JSON, XML, or another structured and delimited format that distinguishes between members at different levels of the hierarchy).

The prompts may also specify a format for providing the reply, through example valid responses to example requests, and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any. If the LLM reply includes a data structure consumable by a code analysis tool, the validation may include verifying that the data structure conforms to a schema expected or used by code analysis tool.

In various embodiments, the code analysis tool may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The values may be embedded in the delimiters and extracted from the embedded structure to determine values predicted by the LLM. The consumable JSON object may be separated from a remainder of the response for consumption by the code analysis tool to create an executable or otherwise consumable structure to trigger functionality of the code analysis tool.

### Code Semantics in High-Level and Low-Level Programming Languages

An extent to which a ML model trained on a certain text corpus associated with one language can be used (and/or fine-tuned) with vector embeddings of another language may depend on the semantics of each language. High-level programming languages (e.g., C, Python, Java, etc.) typically provide a strong abstraction from details of a computer as opposed to low-level programming languages (e.g., assembly languages, etc.). For example, high-level programming languages may use natural language elements or may automate (or even hide) significant aspects specific to computing systems (e.g., memory management, etc.) or processor architecture to simplify the process of developing a program and/or make program code more understandable than when using a lower-level language.

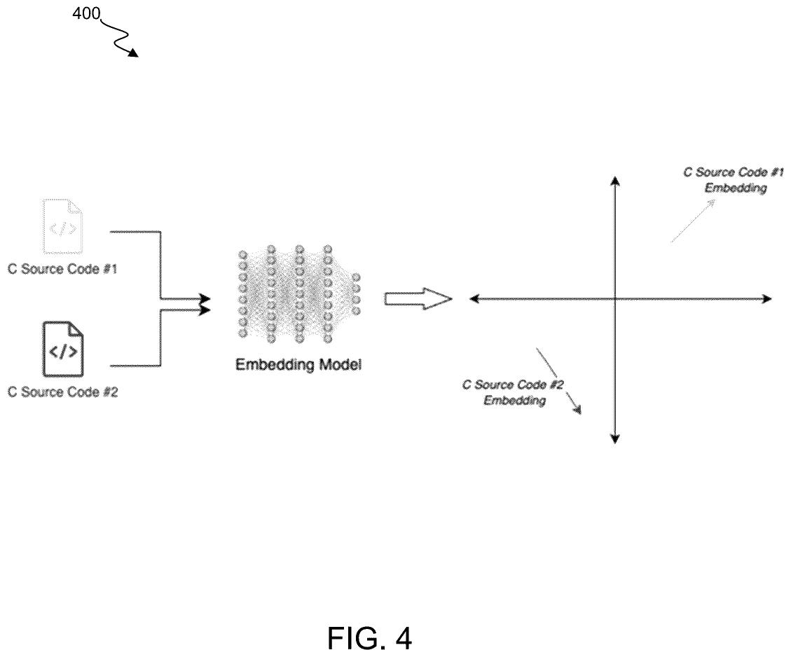

By way of example, consider an example scenario where two source code files written in a high-level programming language (e.g., C) and that are very different in terms of functionality. In this scenario, an example system uses an embedding model (e.g., UniXcoder or any other available embedding model) to determine that the code of the two source code files is logically different because the embeddings of the two files generated by the model are found to significantly different to one another. For example, in this scenario, a cosine similarity score of the vector embeddings of the two source code files is 0.3, which indicates that the embeddings are contextually different from one another. FIG. 4 illustrates a diagram that depicts this example scenario.

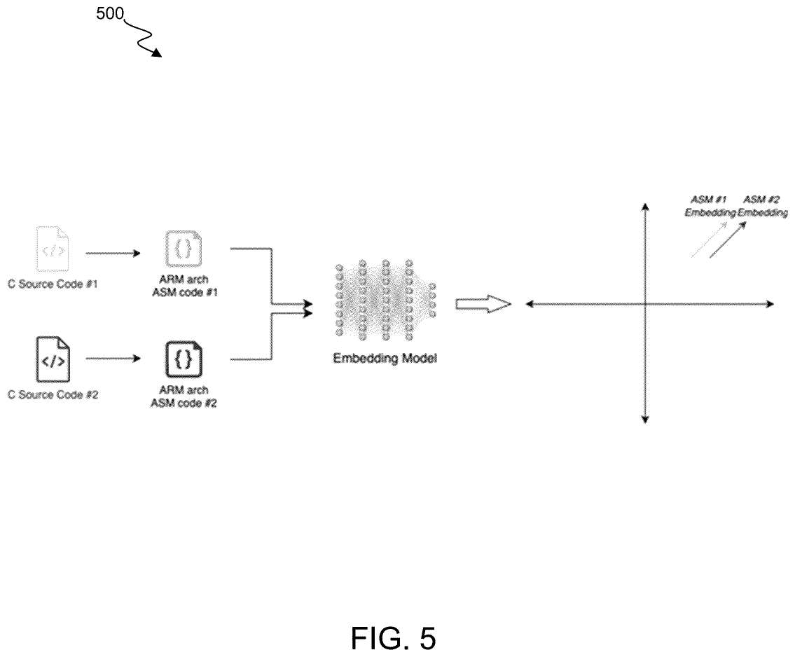

However, as depicted in FIG. 5, embeddings of assembly (e.g., ASM) representations (e.g., assembly files obtained by compiling the C source code files, etc.) generated by inputting these raw assembly files as inputs to the same embedding model may not necessarily indicate the same contextual or semantic similarity results of the original source code files. This discrepancy may be due to an overshadowing impact of registers and memory locations (e.g., number of registers<<number of instructions) associated with the assembly code language, e.g., which may seem to be near-identical across assembly files and thus assembly embeddings may appear to be near identical to one another as well (e.g., cosine similarity score of 0.99). For example, when predicting assembly code instructions (e.g., for a modern 96 architecture), the embedding model may have a choice of more than 1000 possible instructions. However, the number of usable registers may be significantly less than 100. Furthermore, some instructions may be used with two registers as parameters. Thus, in this example, a typical 3-word command in the assembly file may include one word that is an instruction and two words that are registers. Since the number of available registers is relatively small and two thirds (approximately) of the words in the assembly file are registers, the register names may be used repeatedly in the assembly file which may result in the overshadowing effect of registers when building embeddings using a text-based embedding model. In other words, this discrepancy may be related to information entropy, where information that is present with high frequency in a file input to an embedding model might be considered uninteresting whereas information that appears with low frequency may be deemed important. In this case, the registers (e.g., by appearing with much higher frequency than instructions) may diminish the overall variance in the embedding space, causing assembly embeddings to appear overly similar.

In some scenarios, generating vector embeddings for assembly code may provide significant benefits for various downstream code analysis tasks, such as binary code similarity detection, binary deduplication, binary classification, and binary search and retrieval. However, in line with the discussion above, generating these embeddings may be technically challenging because models specifically trained to understand assembly code may not be readily available. In such scenarios, software development teams may train their own models from scratch rather than fine-tuning existing models. However, the process of training new models specific to each assembly language can be resource-intensive, and some applications may not have the necessary computational resources and/or expertise to develop such specialized language models. For example, an assembly language is typically specific to one particular processor architecture and may thus have different semantics than other assembly languages. In some scenarios, it may be impractical to train a set of ML models from scratch for every possible assembly language.

Moreover, in some scenarios, training an assembly code model from scratch presents unique challenges compared to training models for source code (i.e., high-level language) embeddings. In the case of source code for instance, snippets of source code can be extracted and input to a machine learning model to create a semantically rich numerical representation of the input. The primary input in this scenario can be the actual source code text. However, during training more complex structures can also be used as part of a specific training task. This works well for high-level programming languages like Java or C/C++, e.g., because those high-level languages have an information-rich grammar that allows expressing program logic as a combination of syntactic elements (e.g., loop constructs and operators) and includes logically meaningful identifiers referring to programming language constructs (e.g., variable and class names). On the other hand, low-level languages such as assembly (ASM) languages are usually a list of instructions to be executed by the computer. The instructions are often abbreviations (e.g., short-length text abbreviation of a word) that represents an actual operation (e.g., mov, lea, or shl) and may include register names and addresses as parameters. Available register names are limited by computer architecture and usually do not exceed a low two-digit number.

Assembly files typically capture two important categories of information: (1) the sequence of instructions and (2) the data flow between registers. Thus, if a traditional text embedding model (e.g., designed for learning natural language text and/or high-level language source code text) is used to analyze assembly code, such model may not necessarily be able to effectively leverage information about data flow between registers and/or may not recognize registers solely as text elements. Since there is typically a significant imbalance between categories of information relevant to logic flows and/or data flows in assembly code (e.g., the number of available registers of a processor is typically significantly lower than the number of instructions in an assembly code block), an instruction sequence in an assembly code block may provide a larger degree of variation than a corresponding source code snippet written in a higher-level language.

To overcome these challenges, the present disclosure includes example systems and methods that preprocess assembly code in a way that allows an embedding model to generate semantically richer embeddings of the preprocessed assembly code, without necessarily training a new model from scratch specifically on the assembly language of that assembly code. Furthermore, in some examples, the proposed approach can be architecture-agnostic, meaning that it can be used with various assembly architectures (e.g., 96, MIPS, and ARM) to generate semantically rich vector embeddings. Thus, some example systems and methods described herein may advantageously enable users (e.g., security teams, etc.) to leverage a variety of available embedding models (e.g., off-the-shelf embedding models, open source embedding models, natural language text embedding models, source code embedding models, etc.) for a wide range of binary-related downstream code analysis tasks by making these available models applicable to and/or compatible with assembly code as well.

### Pruning and Modifying Assembly Code to Support Fine-Grained Assembly Code Analysis

In some aspects, the present disclosure proposes a framework for preprocessing assembly code to generate a representation that is more semantically rich and thus more suitable for use with an encoder model trained on code related tasks (e.g., but not necessarily trained on assembly code). In some examples, the post-processed assembly code generated according to the proposed scheme can be used to generate a more informative and contextual embedding, even when using embedding models that have not exclusively been trained on assembly code (e.g., open-source models, etc.).

By way of example, an example code semantics system herein removes redundant information (e.g., register names, memory locations, etc.) and/or semantically poor information (e.g., metadata, etc.) from assembly files while keeping semantically rich information (e.g., instructions, etc.) in the assembly code. These modifications may result in a more semantically accurate ASM representation of the original source code and thus a semantically richer embedding for the assembly file(s) as well. As mentioned above, most of the contextually rich information (i.e., with respect to the underlying code logic) in an assembly file is typically found in the sequence of instructions as they are the primary source of logically meaningful variability and/or functional relationships in the code.

In some examples, the code semantics system may remove various types of semantically redundant information (e.g., registers, addresses, headers, etc.), which are typically included in many ASM files thus diluting information-rich portions of code in ASM files. The code semantics system may also remove various types of semantically irrelevant information (e.g., metadata, comments, etc.), such as any information that does not proved contextually rich information about the underlying code functionality (e.g., implementation, flow logic, etc.) of the assembly code.

As an example of redundant and/or irrelevant information removal, the code semantics system may parse an assembly file to remove any metadata found in the assembly file. Metadata includes information that is typically found near a beginning of ASM files, such as headers, operating system (OS) versions on which the ASM was compiled, software development kit (SDK) versions, and so on. In some configurations, metadata like function names (e.g., as a dependency of compiler optimizations) can be either kept or removed from the assembly file (e.g., depending on user preferences, etc.). The code semantics system may also parse the assembly file to find and remove Call Frame Information (CFI) directives, e.g., information that may be useful for debugging but does not necessarily influence program logic (e.g., ‘.cfi_startproc’, ‘cfi_endpoint’). The code semantics system may also parse the assembly file to remove comments. Alternatively, in some configurations, the code semantics system may be configured to keep the comments (e.g., based on user preferences). The code semantics system may also parse the assembly file to remove stack adjustments. Stack adjustments, while useful for memory management, generally does not affect the core program logic and does not change a logical meaning of the instructions in the assembly code, and thus stack adjustments may not be useful for creating semantic embeddings.

In some instances, the code semantics system may also parse the assembly file to remove registers. For instance, some computer architectures have a small number of usable registers. When the assembly file is compiled, the compiler allocates these registers to hold parameters required by the instructions in the assembly code. Hence, the variation of registers is very limited and determined by the computer architecture (i.e., the same register can be reused many times) as well as internal compiler logic. Therefore, the usage of most registers in assembly code does not necessarily provide useful contextual information (with respect to the underlying code logic). For example, within the following example ASM code block: “stp x29, x30, [sp, #16]”. In this example, x29 and x30 may be parameters of an ARM-based store-pair-of-registers processor operation. In this example, the code semantics system may optionally prune this information by removing the registers ‘x29’ and ‘x30’ from the ASM code block as they may be deemed as not providing sufficient information about the core functionality of the code and thus are not useful for creating semantic embeddings (e.g., even though they might be useful for stack frame integrity).

In some examples, the code semantics system alternatively or additionally modifies assembly files (and/or redundant/irrelevant information therein) to a form that is more useful for embedding models (e.g., a more semantically relevant form). For instance, the example code semantics system may add information (e.g., instruction tokens, etc.) to provide additional contextually-relevant and/or semantically-relevant information in the preprocessed assembly code representation than the original assembly code.

As an example of modifying assembly files to incorporate semantic information and/or context information about the underlying logic flow, an example code semantics system may modify registers listed in an assembly file by augmenting the registers to clarify dependencies and/or data flow. Alternatively or additionally, the code semantics system may add a token (e.g., [INST]) at the end of each register name and/or instruction line to differentiate the role of the register in different instructions (e.g., ‘ADD’ instructions, ‘SUB’ instructions, etc.). For instance, consider a scenario where an ADD instruction receives three registers as parameters (e.g., ADD R1, R2, R3). In this scenario, the processor computes a sum of the two latter registers (e.g., R2 and R3) and stores the result of the sum computation in the first register. Below is an example assembly code snippet that includes the ADD command repeatedly in a sequence of three instructions.

### Example Code Snippet 1 (CS1)

ADD R5, R1, R2
ADD R5, R5, R3
ADD R5, R5, R4

If written in a high-level programming language (e.g., C or Java), the logic flow of CS1 may be expressed as “r=a+b+c+d”. Thus, the logical meaning of this assignment statement may be semantically much clearer in the high-level language than in the assembly code snippet CS1, due to the repetitive reuse of register R5. Thus, to improve semantic relevance of assembly code like CS1, an example code semantics system may modify the assembly code to semantically indicate and/or track such data dependencies between registers used in the assembly code. For example, the code semantics system may modify CS1 to add a version tag or token to each register name, as shown below in example code snippet 2 (CS2).

### Example Code Snippet 2 (CS2)

ADD R5_0, R1_0, R2_0
ADD R5_1, R5_0, R3_0
ADD R5_2, R5_1, R4_0

In the example of CS2, the code semantics system modified the original register name (e.g., R1, R2, R3, R4, R5) by adding tokens or version numbers (e.g., “0”, “1”, etc.) at the end of the registers to track register data dependencies, e.g., by effectively incorporating the register dependency graph directly into the assembly file. Thus, this modification results in a richer semantic representation of the underlying code logic which could facilitate generating a more semantically rich vector embedding as well. In various examples, the code semantics system may modify assembly code similarly to incorporate relatively more advanced dataflow information to improve the semantic relevance of the original assembly code with respect to the underlying code logic.

As another example of modifying assembly code to improve its semantic or contextual relevance, an example code semantics system may further align registers in the assembly code in a manner that is consistent with a sequential format expected by language models. For example, the code semantics system may add an instruction token (e.g., [INST]) at the end of each register and/or at the end of each machine instruction to provide additional context information about the machine instruction, the register(s), and/or their respective sequential significance in the code logic. Such a modification may improve embedding model results as the embedding model may learn to associate registers with these specialized tokens, e.g., by incorporating information about sequential dependencies in the preprocessed assembly code.

In some aspects, the proposed framework includes preventing modifications and/or removals for one or more predefined types of assembly code instructions (e.g., instructions that are semantically relevant to logic flow, etc.). For example, the code semantics system may be configured to skip removing or modifying assembly code instructions such as RET (e.g., instruction for returning control to a caller) to avoid changing a logical meaning of the underlying program execution or logic flow, and/or BLR (e.g., branch with link to register) which is also an instruction relevant to a logic flow of the program.

Example pseudo-code (CS3) of an algorithm that implements an example ASM code processing framework for pruning and/or modifying assembly code in line with the discussion above is presented below. It is noted that the various rules represented int his example framework may be varied depending on user preferences and/or other application-specific considerations. For example, lines 9-10 of the example pseudo-code indicate an implementation where register names are modified to add a register version, in line with the example of CS2 above. In alternative or additional examples, the framework may instead involve removing the registers from the assembly code (e.g., instead of the register versions).

### Example Pseudo-Code (CS3)

Example Algorithm for ASM Code Processing Framework

| | |
|---|---|
| 1 | Parse ASM Code block using tree-sitter to create a syntax tree T |
| 2 | for each line in T do |
| 3 | if line is not instruction then |
| 4 | Del line from code |
| 5 | else if line is instruction then |
| 6 | for each child_node of instruction do |
| 7 | if child_node is comment then |
| 8 | Del comment from line |
| 9 | else if child_node is register then |
| 10 | Mod register => register_version from line |
| 11 | else if child_node is stack_adjustment then |
| 12 | Del stack_adjustment from line |
| 13 | end if |
| 14 | end for |
| 15 | if instruction_type is in [str, ldr, bl, ret] then |
| 16 | Keep instruction as is |
| 17 | end if |
| 18 | Append ‘[INST]’ to line |
| 19 | end if |
| 20 | end for |
| 21 | return Processed ASM code |

### Generating Semantically Rich Assembly Code Representations and Vector Embeddings

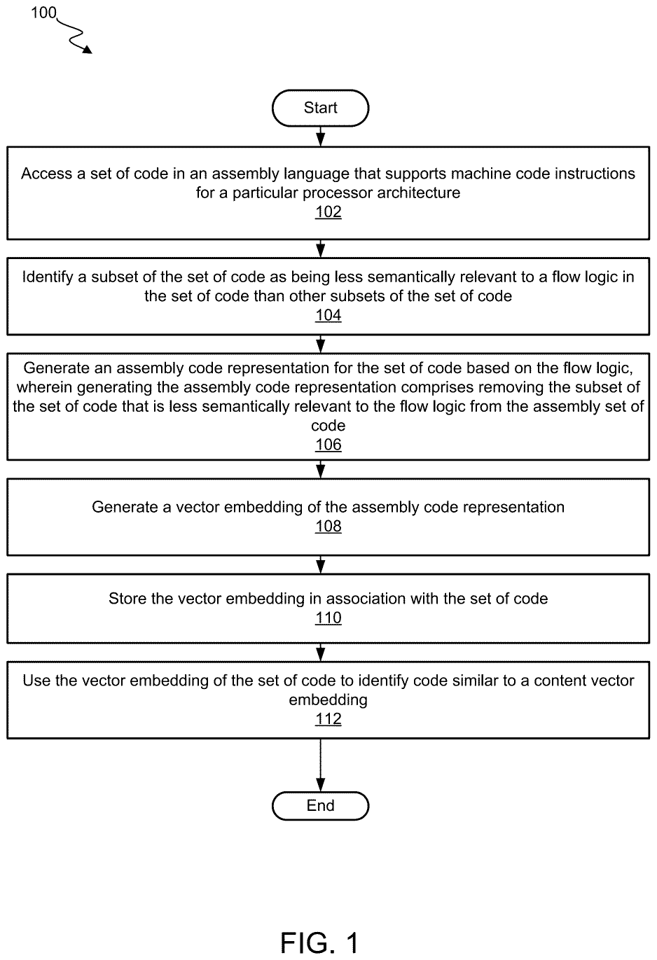

FIG. 1 illustrates a flow chart of an example process 100 that parses assembly code to generate semantically rich assembly code representations and vector embeddings. The process 100 begins at 102, where an example code semantics system accesses a set of code (e.g., assembly file) in an assembly language that supports machine code instructions for a particular processor architecture. For example, a user may enter, select, or otherwise identify an assembly code file or other assembly code set via a user interface of the code semantics system.

At 104, process 100 includes the example code semantics system identifying a subset of the set of code as being less semantically relevant to a flow logic in the set of code than other subsets of the set of code. For example, the code semantics system may parse an assembly file (e.g., the set of code) to identify an ASM code block that includes a sequence of machine code instructions. In this example, the code semantics system may then deem code other than that ASM code block (e.g., metadata, comments, etc.) as the subset of the set of code that is not semantically relevant to the underlying program logic (e.g., flow logic) of the assembly file.

In some examples, process 100 includes the code semantics system identifying a particular subset of the set of code that corresponds to the logic flow using a syntax tree.

In some examples, process 100 includes the code semantics system identifying the subset of the set of code that is less semantically relevant to the logic flow than other subsets of the set of code at 104 based on the syntax tree (e.g., tree node may indicate syntax as header or metadata, etc.).

At 106, process 100 includes the example code semantics system generating an assembly code representation for the set of code based on the flow logic, where generating the assembly code representation includes the code semantics system removing the subset of the set of code that is less semantically relevant to the flow logic (e.g., identified at 104) from the assembly set of code. For example, the code semantics system may remove irrelevant or redundant information such as metadata, comments, etc. from the assembly code so that the processed assembly code (e.g., the assembly code representation generated at 106) becomes more semantically relevant to the underlying code logic.

In some examples, removing the subset of the set of code from the assembly code representation comprises removing one or more of: metadata, call frame information (CFI), debugging information, comments, registers, stack adjustments, or memory allocation information.

In some examples, generating the assembly code representation further comprises modifying content extracted from the set of code and included in the assembly code representation to incorporate semantic or contextual information about the flow logic in the assembly code representation.

In some examples, modifying the content comprises modifying register labels to semantically distinguish at least one of data flow or register dependencies in the assembly code representation.

In some examples, modifying the content comprises inserting a token to semantically associate the content with a register or to semantically indicate a sequential dependency of one or more machine code instructions associated with the register.

At 108, process 100 includes the example code semantics system generating a vector embedding of the assembly code representation. For example, the code semantics system can use the semantically rich assembly code representation (generated at 106) as input to an embedding model (e.g., UniXcoder, etc.) to generate the vector embedding for the set of code.

In some examples, generating the vector embedding comprises providing the assembly code representation to an embedding model, and receiving the vector embedding from the embedding model.

At 110, process 100 includes the example code semantics system storing the vector embedding in association with the set of code. For example, the code semantics system may store the vector embedding in a vector database or index for code retrieval with reference to the assembly code file and/or other code files.

At 112, process 100 includes the example code semantics system using the vector embedding of the set of code to identify code similar to a content vector embedding. For example, the code semantics system may compare the vector embedding with a content vector embedding of another set of code to identify code similarities between the two sets of code.

In some examples, process 100 also includes the code semantics system accessing a second set of code associated with the logic flow and that is in a second assembly language associated with a second processor architecture, generating a second assembly code representation for the second set of code based on the flow logic, and generating a second vector embedding of the second assembly code representation.

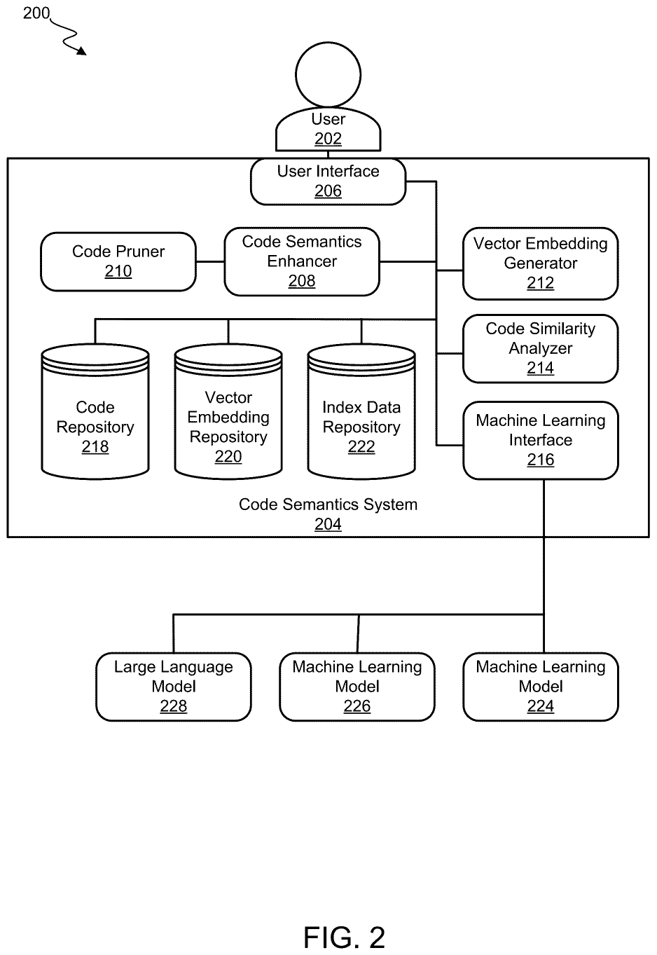

FIG. 2 illustrates a system diagram 200 showing an example code semantics system 204 that parses assembly code to generate semantically rich assembly code representations and vector embeddings. The code indexing system 204 includes a user interface 206, a code semantics enhancer 208, a code pruner 210, a vector embedding generator 212, a code similarity analyzer 214, a machine learning interface 216, a code repository 218, a vector embedding repository 220, and an index data repository 222.

The user interface 206 includes any combination of hardware and/or software configured to receive inputs and/or provide outputs to a user 202 of the code indexing system 204. For example, the user interface 206 may include a graphical user interface (GUI) that receives a search query or other input indicative of a piece of assembly code and then provides output indicating a semantically rich representation of the assembly code and/or a semantically rich vector embedding.

The code semantics enhancer 208 includes any combination of hardware and/or software configured to receive a set of code in an assembly language and provide a semantically rich assembly code representation and/or a semantically rich vector embedding of the original code as output.

The code pruner 210 includes any combination of hardware and/or software configured to prune the extracted code subset(s) to remove one or more of the code subset(s) from the assembly code that are semantically irrelevant and/or redundant to the flow logic of the input assembly code.

The vector embedding generator 212 includes any combination of hardware and/or software configured to generate a vector embedding for the generated semantically rich assembly code representation. For example, the vector embedding generator 212 may use machine learning interface 216 to determine numerical values (i.e., vector embeddings) representing patterns associated with the semantically rich assembly code representation.

The code similarity analyzer 214 includes any combination of hardware and/or software configured to analyze similarity between two sets of code. For example, the code similarity analyzer 214 may perform a vector distance computation to identify similarities between a vector embedding corresponding to a first set of code and another vector embedding corresponding to a second set of code. The vector distance may indicate an extent to which the two sets of code are similar.

The machine learning interface 216 includes any combination of hardware and/or software configured to interface with one or more of machine learning model 224, 226 and/or large language model 228. For example, the machine learning interface 216 may be configured to train the machine learning model 224 and/or 226 to predict vector embeddings for a set of code. As another example, the machine learning mode 216 may configure the large language model 228 to generate and/or predict vector embeddings by prompting the large language model 228 using a retriever augmented generation (RAG) process.

The code repository 218 includes any combination of hardware and/or software configured to store one or more source code files, a codebase, or any other representation of code. To that end, the code repository 218 may include a database, a file server, or any other suitable data storage medium.

The vector embedding repository 220 includes any combination of hardware and/or software configured to store vector embeddings corresponding to one or more sets of code and/or one or more subsets of a particular set of code. To that end, the vector embedding repository 220 may include a database, a file server, or any other suitable data storage medium.

The index data repository 222 includes any combination of hardware and/or software configured to store index information (e.g., location of code associated with vector embedding, etc.) corresponding to one or more sets of code and/or one or more subsets of a particular set of code. To that end, the vector embedding repository 220 may include a database, a file server, or any other suitable data storage medium.

Relevant information may be identified for inclusion in the index for code retrieval, as a vector embedding used to train machine learning models 224 and/or 226 or as RAG or to configure a large language model prompt of the large language model 228 for instance. For example, the code indexing system 204 can compare two pieces of code by using a common embedding technique across both a first piece of code and a second piece of code. The common embedding technique may output vector embeddings for code snippets, and a similarity of the vector embeddings may be determined using a variety of vector distance techniques to find code vector embeddings that are closest or within a threshold distance of other vector embeddings (e.g., a content vector embedding representing a search query or other input).

In one embodiment, vectors of similar distance may be determined for an input vector using a vector database. The vector database may receive, as input, a content vector embedding representing a piece of code in a search query or other input. The vector database may then identify, using vector distances, another set of data, such as a code snippet stored in the code repository database 218 that is closest to the input vector embedding.

The code similarity analyzer 214 may determine similarities between vectors by calculating a similarity measure and optionally ranking pairs based on similarity or comparing the similarity measure to a threshold value. For numerical or vector data, the data code similarity analyzer 214 may use any distance function or other method of determinations of numerical or vector similarities, such as Cosine Distance, the Euclidean Distance, the Pearson Correlation Coefficient, the Manhattan Distance, the Minkowski Distance, the Hamming Distance, the Chebyshev Distance, the Jaccard Distance, the Sorensen-Dice Distance, the Pearson correlation coefficient, the Levenshtein distance, or any other means of calculating correlation. For text data, the correlation may be determined by first converting the text to embeddings in vector space in a large language model, which can then be compared using any of the above methods for determining the similarity between vectors. The text embeddings may reduce semantic meanings within the text to numerical values corresponding to the detected semantic meanings. In this way, the correlation between columns is based on the meanings of the words of the text data.

The distance or similarity analysis may be performed on the whole vector embedding or by breaking up vectors into components to determine correlation of corresponding components across the vectors. For example, a first vector and a second vector may each include a component that indicates a method that includes a loop, and the information about the loop may be correlated across vectors even though the rest of the vector is not correlated. A correlation or similarity between vectors may be determined by comparing the correlation determined according to the similarity measure to a similarity threshold. The vectors may be counted as similar if the similarity measure exceeds the similarity threshold. In an alternative embodiment, the vectors may be compared to determine correlation clusters, where columns or components of the vectors or vectors themselves are determined to be part of a cluster if the correlation between all combinations of columns, components, or vectors in the cluster is above a certain threshold.

A Pearson Correlation Coefficient between two vectors is calculated as a ratio between the covariance between the vectors and the product of the standard deviations between the two vectors. A correlation coefficient of 1 represents identical vectors, a correlation coefficient of −1 represents opposite vectors, and a correlation coefficient of 0 represents vectors that are not correlated.

A Cosine Distance or cosine similarity between two vectors is determined by calculating a cosine of the angle between the two vectors. A result of 1 represents a cosine similarity between two identical, a result of −1 represents a cosine similarity between two opposite vectors, and a result of 0 represents a cosine similarity between two unrelated or orthogonal vectors.

A Euclidean Distance is determined by calculating a square root of a sum of the squares of the distances between components of the two vectors. The higher the Euclidean distance, the lower the similarity between the components of the vectors used in the calculation.

A Manhattan Distance is calculated as a sum of the absolute differences between components of the vectors. The higher the Manhattan Distance, the lower the similarity between the components of the vectors used in the calculation.

A Minkowski Distance is calculated as the p-th root of the sum of the absolute differences between components of the vectors raised to a power, p, for each component pair. The Minkowski Distance equals the Manhattan Distance when p=1 and the Euclidean Distance when p=2. The higher the Minkowski Distance, the lower the similarity between the components of the vectors used in the calculation.

A Hamming Distance between two vectors is determined based on how many positions at which corresponding components of the vectors are different or sufficiently different. For each component pair in the vectors that are different, a counter is incremented. The Hamming Distance is the total counter for the vectors across all component pairs.

A Chebyshev Distance between two vectors is calculated as the greatest of the absolute differences among the vectors' corresponding components. The largest absolute difference among all the pairs of components is the Chebyshev Distance. The larger the Chebyshev Distance, the lower the similarity between the vectors.

A Jaccard Distance between two vectors is calculated as a ratio between the size of the intersection between the vectors (based on elements in common between the vectors) to the size of the union between the vectors (based on elements in either or both of the vectors). Jaccard Similarity is defined by the ratio, and Jaccard Distance is defined as one minus the Jaccard Similarity.

The Sorensen-Dice Similarity is calculated as two times the number of elements in common among the vectors divided by the sum of the number of elements in each vector. The Sorensen-Dice Distance is one minus the Sorensen-Dice Similarity.

A Levenshtein Distance is a string similarity metric used to measure the minimum number of single-character allowed operations (insertions, deletions, or substitutions) required to transform one string into another.

### Example Applications of Semantically Rich Vector Embeddings for Assembly Files

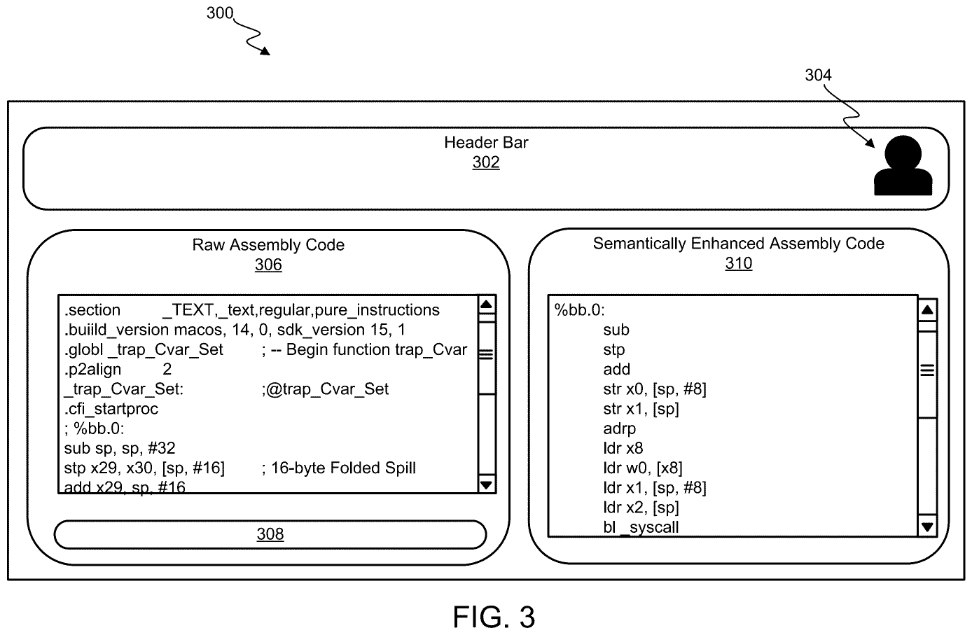

FIG. 3 illustrates a diagram of an example user interface 300 showing an example code semantics system that modifies raw assembly code to generate semantically enhanced assembly code according to a flow logic in the assembly code. The user interface 300 includes a header bar 302, which may be a GUI element that includes various information about a user session of a user accessing the user interface 300. For example, a user account graphic indicator 304 may indicate a user account associated with the user session. The user interface 300 also includes a raw assembly code viewer 306, an input element 308, and a semantically enhanced assembly code viewer 3310.

The raw assembly code viewer 306 may include a GUI element configured to display a set of code that is to be split into one or more code subsets that can be processed, for example, for generating a semantically rich assembly code representation or vector embedding.

The input element 308 may include any combination of GUI input elements configured to select and/or submit a set of code for processing by an example code indexing system. For example, the input element 308 can be used to select an assembly file or to enter assembly code for processing by the code semantics system 204.

The semantically enhanced assembly code viewer 310 may include a GUI element configured to display the semantically rich assembly code generated by the system 300 according to process 100.

FIG. 4 illustrates a diagram 400 of an example of generating vector embeddings from source code files that implement different logic flows in a high-level programming language.

FIG. 5 illustrates a diagram 500 of an example of generating vector embeddings from assembly files that implement different logic flows in an assembly language.

As shown in FIG. 5, the vector embeddings of the assembly code files seem similar to one another unlike the vector embeddings of the source code files depicted in FIG. 4 even the respective code logic is equivalent.

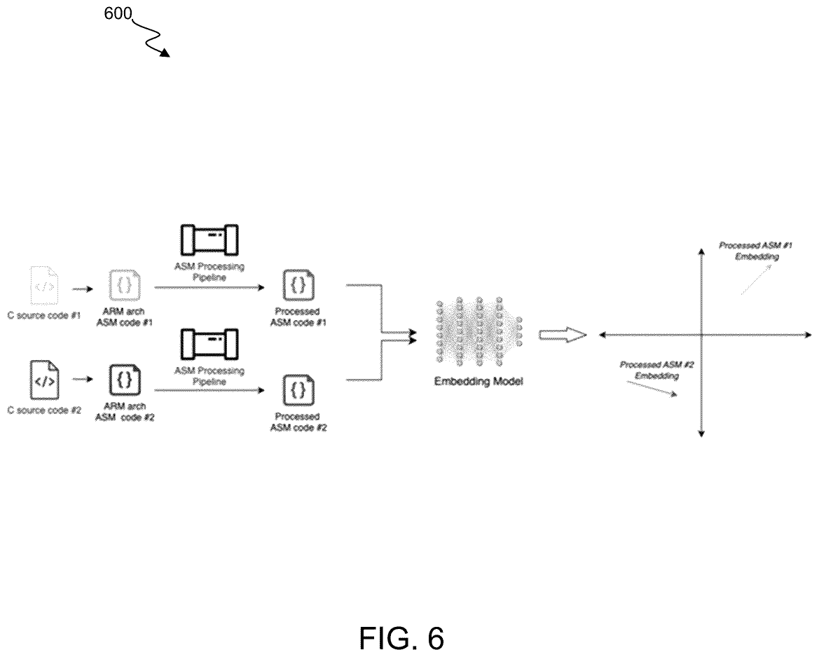

FIG. 6 illustrates a diagram 600 of an example of preprocessing assembly files to generate semantically rich assembly code representations prior to generating vector embeddings for the assembly files.

As shown in FIG. 6, the vector embeddings generated using preprocessed assembly code representations are more distinguishable (e.g., similar to those of the original source code files as depicted in FIG. 4).

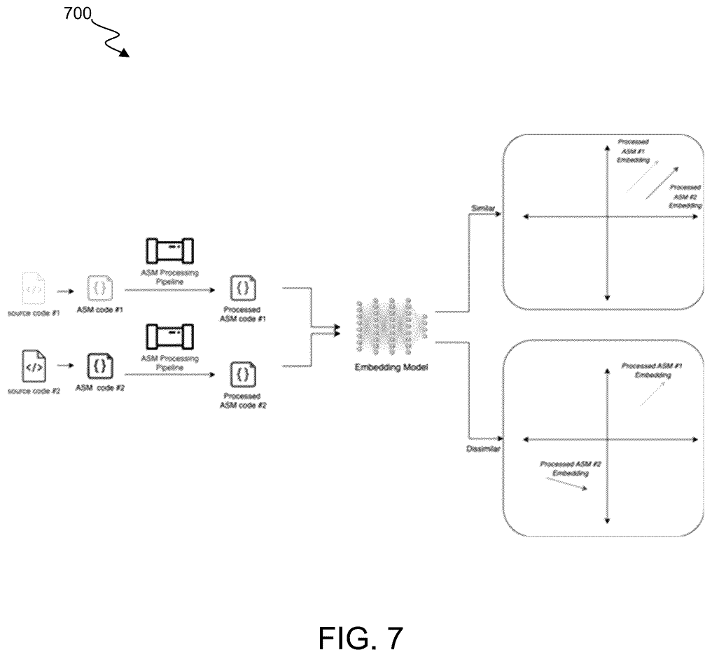

FIG. 7 illustrates a diagram 700 of an example of using vector embeddings of semantically rich assembly code representations for code similarity analysis. For example, code semantics system 204 can be used to compare vector embeddings of the two pre-processed ASM code representations to determine whether code logic of the two ASM codes is similar or dissimilar.

In some examples, the present method improves vector embeddings generated using embedding models (e.g., uniXcoder) that have not been specifically trained on the assembly code so as to generate semantically rich embeddings. Furthermore, the present approach allows a system to differentiate between ASM embeddings more accurately. For example of FIGS. 3, the cosine similarity score of the original assembly code and processed assembly codes (when compared another assembly file) improves from 0.99 to 0.54, a much more accurate representation of the differences between the 2 ASM files. In another example, two similar source code files (e.g., C) have a cosine similarity score between the source code files of 0.9936. After compiling to assembly files, the similarity between the raw assembly files increased to 0.9976. Following preprocessing, the similarity between the processed assemblies remained high at 0.99. These results demonstrate that the preprocessing framework of the present disclosure effectively preserves the high similarity between the assembly codes after they have been processed.

### Computer System Architecture

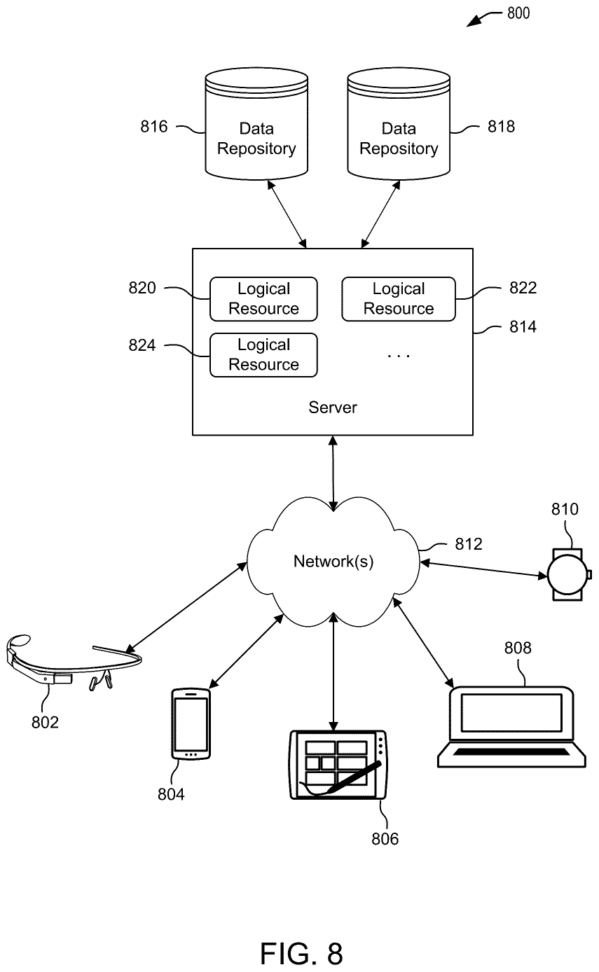

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for generation of semantically rich assembly code representations and embeddings.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for generation of semantically rich assembly code representations and embeddings in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 814 may be composed of one or more general purpose computers, specialized server computers (including, by way of example, PC (personal computer) servers, UNIX® servers, LINUX© servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for generation of semantically rich assembly code representations and embeddings. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

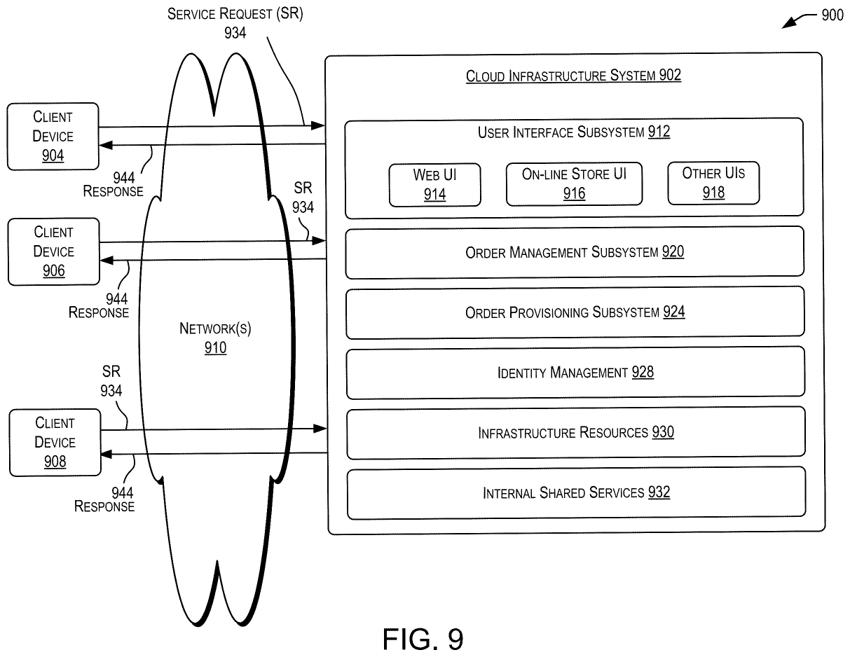

FIG. 9 is a simplified block diagram of a cloud-based system environment in which semantically rich assembly code representations and embeddings are generated, in accordance with certain aspects. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise a service management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the service provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

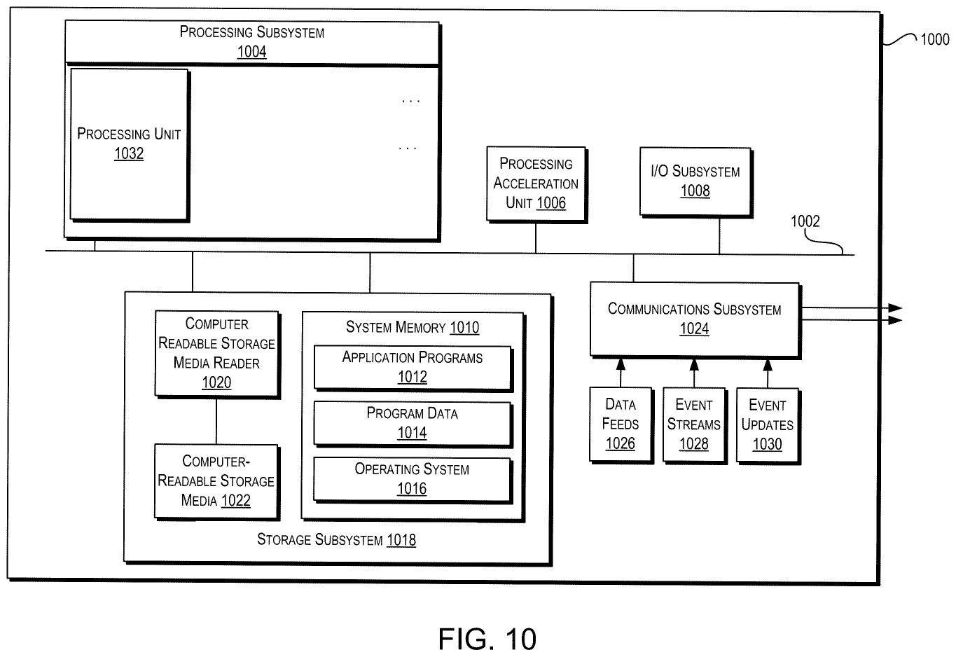

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory and/or transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a set of code in an assembly language that supports machine code instructions for a particular processor architecture;
identifying a subset of the set of code as being less semantically relevant to a flow logic in the set of code than other subsets of the set of code;
generating an assembly code representation for the set of code based on the flow logic, wherein generating the assembly code representation comprises removing the subset of the set of code that is less semantically relevant to the flow logic from the assembly code representation;
generating a vector embedding of the assembly code representation;
storing the vector embedding in association with the set of code; and
using the vector embedding of the set of code to identify code similar to a content vector embedding.

2. The computer-implemented method of claim 1, wherein removing the subset of the set of code from the assembly code representation comprises removing one or more of: metadata, call frame information (CFI), debugging information, comments, registers, stack adjustments, or memory allocation information.

3. The computer-implemented method of claim 1, wherein generating the assembly code representation further comprises:
modifying content extracted from the set of code and included in the assembly code representation to incorporate semantic or contextual information about the flow logic in the assembly code representation.

4. The computer-implemented method of claim 3, wherein modifying the content comprises modifying register labels to semantically distinguish at least one of data flow or register dependencies in the assembly code representation.

5. The computer-implemented method of claim 3, wherein modifying the content comprises inserting a token to semantically associate the content with a register or to semantically indicate a sequential dependency of one or more machine code instructions associated with the register.

6. The computer-implemented method of claim 1, wherein generating the vector embedding comprises:
providing the assembly code representation to an embedding model; and
receiving the vector embedding from the embedding model.

7. The computer-implemented method of claim 1, further comprising:
identifying a particular subset of the set of code that corresponds to the logic flow using a syntax tree.

8. The computer-implemented method of claim 7, further comprising:
identifying the subset of the set of code that is less semantically relevant to the logic flow than other subsets of the set of code based on the syntax tree.

9. The computer-implemented method of claim 1, further comprising:
accessing a second set of code associated with the logic flow and that is in a second assembly language associated with a second processor architecture;
generating a second assembly code representation for the second set of code based on the flow logic; and
generating a second vector embedding of the second assembly code representation.

10. The computer-implemented method of claim 1, further comprising receiving the set of code in the assembly language from a compiler that compiles source code in a different source code language to generate the set of code.

11. A computer-program product comprising one or more non-transitory machine-readable storage media, including stored instructions configured to cause a computing system to perform a set of actions including:
accessing a set of code in an assembly language that supports machine code instructions for a particular processor architecture;
identifying a subset of the set of code as being less semantically relevant to a flow logic in the set of code than other subsets of the set of code;
generating an assembly code representation for the set of code based on the flow logic, wherein generating the assembly code representation comprises removing the subset of the set of code that is less semantically relevant to the flow logic from the assembly code representation;
generating a vector embedding of the assembly code representation;
storing the vector embedding in association with the set of code; and
using the vector embedding of the set of code to identify code similar to a content vector embedding.

12. The computer-program product of claim 11, wherein removing the subset of the set of code from the assembly code representation comprises removing one or more of: metadata, call frame information (CFI), debugging information, comments, registers, stack adjustments, or memory allocation information.

13. The computer-program product of claim 11, wherein generating the assembly code representation further comprises:
modifying content extracted from the set of code and included in the assembly code representation to incorporate semantic or contextual information about the flow logic in the assembly code representation.

14. The computer-program product of claim 13, wherein modifying the content comprises modifying register labels to semantically distinguish at least one of data flow or register dependencies in the assembly code representation.

15. The computer-program product of claim 11, wherein modifying the content comprises inserting a token to semantically associate the content with a register or to semantically indicate a sequential dependency of one or more machine code instructions associated with the register.

16. A system comprising:
one or more processors;
one or more non-transitory computer-readable media storing instructions, which, when executed by the system, cause the system to perform a set of actions including:
accessing a set of code in an assembly language that supports machine code instructions for a particular processor architecture;
identifying a subset of the set of code as being less semantically relevant to a flow logic in the set of code than other subsets of the set of code;
generating an assembly code representation for the set of code based on the flow logic, wherein generating the assembly code representation comprises removing the subset of the set of code that is less semantically relevant to the flow logic from the assembly code representation;
generating a vector embedding of the assembly code representation;
storing the vector embedding in association with the set of code; and
using the vector embedding of the set of code to identify code similar to a content vector embedding.

17. The system of claim 16, wherein the set of actions further includes:
identifying a particular subset of the set of code that corresponds to the logic flow using a syntax tree; and
identifying the subset of the set of code that is less semantically relevant to the logic flow using the syntax tree.

18. The system of claim 16, wherein the set of actions further includes:
identifying the subset of the set of code that is less semantically relevant to the logic flow than other subsets of the set of code based on the syntax tree.

19. The system of claim 16, wherein the set of actions further includes:
accessing a second set of code associated with the logic flow and that is in a second assembly language associated with a second processor architecture;
generating a second assembly code representation for the second set of code based on the flow logic; and
generating a second vector embedding of the second assembly code representation.

20. The system of claim 16, wherein the set of actions further includes receiving the set of code in the assembly language from a compiler that compiles source code in a different source code language to generate the set of code.
